(19) United States
(12) Patent Application Publication
(10) Pub. No.: US 2018/0174781 A1
(43) Pub. Date: Jun. 21, 2018

(54) SWITCHING DEVICE

(71) Applicant: Johnson Electric S.A., Murten (CH)

(72) Inventor: Gerhard FANGMANN, Marienheide (DE)

(21) Appl. No.: 15/843,872

(22) Filed: Dec. 15, 2017

(30) Foreign Application Priority Data
Dec. 16, 2016 (DE) 10 2016 015 050.5

(51) Int. Cl. H01H 21/22; H01H 21/36; H01H 1/36; E06B 9/72

(52) U.S. Cl. CPC H01H 21/22; E06B 9/72; H01H 1/36; H01H 21/36

(57) ABSTRACT

A switching device for an electrically driven curtain includes a contact system. The contact system includes at least one sliding contact and contact tracks, which are housed in a sleeve-shaped projection. The contact tracks are provided on a connection plate, which is electrically connected to an electric driving device. The position of the sliding contacts can be changed by the pivoting movement of a switching lever.

### CROSS REFERENCE TO RELATED APPLICATIONS

This non-provisional patent application claims priority under 35 U.S.C. § 119(a) from Patent Application No. 102016015050.5 filed in Germany on Dec. 16, 2016.

### FIELD OF THE INVENTION

The invention relates to a switching device, in particular for an electrically driven curtain, for example, for roller blinds, blinds, awnings or the like.

### BACKGROUND OF THE INVENTION

Devices for winding and unwinding a curtain are known in various designs. Here, the winding and unwinding of the curtain is manually operated or by a drive device. The curtain can be lifted and/or lowered alone on drawstrings, or the drawstrings are rolled up and down by means of a winding shaft. In electrically driven curtain, the arranged above the drive device includes not only motor and transmission but also several switches for changing rotation direction of the motor. These switches are arranged in the axial direction of the winding shaft at a distance from each other and are connected via an actuating element which moves in the axial direction. Such a switching device is disadvantageous due to the large space requirement for the necessary switches.

Hence there is a desire for an improved switching device which is constructed in particular more compact.

### BRIEF DESCRIPTION OF THE DRAWINGS

A preferred embodiment of the invention will now be described, by way of example only, with reference to figures of the accompanying drawings. In the figures, identical structures, elements or parts that appear in more than one figure are generally labelled with a same reference numeral in all the figures in which they appear. Dimensions of components and features shown in the figures are generally chosen for convenience and clarity of presentation and are not necessarily shown to scale. The figures are listed below.

FIG. 1 is a schematic illustration of a switching device according to one embodiment of the present invention;

FIG. 2 illustrates the switching device of FIG. 1, wherein the switching device is in an off position;

FIG. 3 illustrates the switching device of FIG. 1, wherein the switching device is in a closed position;

FIG. 4 illustrates the switching device of FIG. 1, wherein the switching device is in another closed position;

FIG. 5 is a schematic illustration of a switching device from front view according to another embodiment of the present invention, wherein the switching device is in an off position;

FIG. 6 illustrates the switching device of FIG. 5 from back view, wherein the switching device is in an off position;

FIG. 7 illustrates the switching device of FIG. 5 from front view, wherein the switching device is in a closed position;

FIG. 8 illustrates the switching device of FIG. 5 from back view, wherein the switching device is in a closed position;

FIG. 9 illustrates the switching device of FIG. 5 from front view, wherein the switching device is in another closed position;

FIG. 10 illustrates the switching device of FIG. 5 from back view, wherein the switching device is in another closed position;

FIG. 11 illustrates the sectional view of switching device of FIG. 5, wherein the switching device is in an off position;

FIG. 12 illustrates the sectional view of switching device of FIG. 5, wherein the switching device is in a closed position;

FIG. 13 illustrates the sectional view of switching device of FIG. 5, wherein the switching device is in another closed position;

FIG. 14 is a schematic illustration of the switching device according to the another embodiment of the present invention.

### DETAILED DESCRIPTION OF THE PREFERRED EMBODIMENTS

Hereinafter technical solutions in embodiments of the present disclosure are described clearly and completely in conjunction with the drawings in embodiments of the present disclosure. Apparently, the described embodiments are only some rather than all of the embodiments of the present disclosure. Any other embodiments obtained based on the embodiments of the present disclosure by those skilled in the art without any creative work fall within the scope of protection of the present disclosure. It is understood that, the drawings are only intended to provide reference and illustration, and not to limit the present disclosure. The connections in the drawings are only intended for the clearance of description, and not to limit the type of connections.

It should be noted that, if a component is described to be “connected” to another component, it may be connected to another component directly, or there may be an intervening component simultaneously. All the technical and scientific terms in the present disclosure have the same definitions as the general understanding of those skilled in the art, unless otherwise defined. Herein the terms in the present disclosure are only intended to describe embodiments, and not to limit the present disclosure.

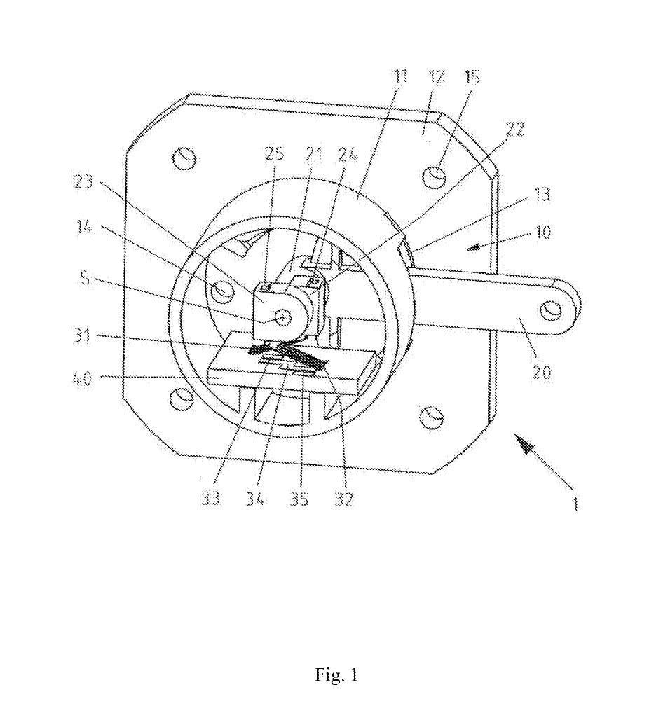

The switching device is shown in FIG. 1 according to one embodiment of the present disclosure. The switching device 1 is configured for an electric powered curtain. The curtain is not shown. The switching device 1 is used in a curtain device for controlling the curtain pulling up in a closed position S1 or pulling down in another closed position S2.

For the different movements of the curtain, an electric driving device is provided, which can move in two different directions of rotation. For connection to this electric driving device, two different connections are provided which correspond to different contacts of a contact system. In at least one embodiment, the switching device 1 comprises a contact system of sliding contacts 31, 32 on the one hand and contact tracks 33, 34, 35 on the other hand. The contact tracks 33, 34, 35 are located on one side of a connection plate 40. On the other side of the connection plate 40, the corresponding connections for the electric driving device of the curtain are provided, which are not shown in the figures. The contact tracks 33, 34, 35 have a linear course and are arranged parallel to each other.

The contact system comprising the sliding contacts 31, 32 and the contact tracks 33, 34, 35 is accommodated in a sleeve-shaped projection 11 of a bearing element 10. This cup-shaped bearing element 10 comprises, in addition to the sleeve-shaped projection 11, a bearing plate 12 which surrounds the sleeve-shaped projection 11 with a flange edge and fastening openings 15, for example for screws, for connection to the curtain device on this flange edge. The sleeve-shaped projection 11 receives the contact system and comprises a slot-shaped recess 13 on one side for a switching lever 20. This slot-shaped recess 13 is dimensioned so that the switching lever 20 in the closed position S1 or S2 abuts one side of the slot-shaped recess 13.

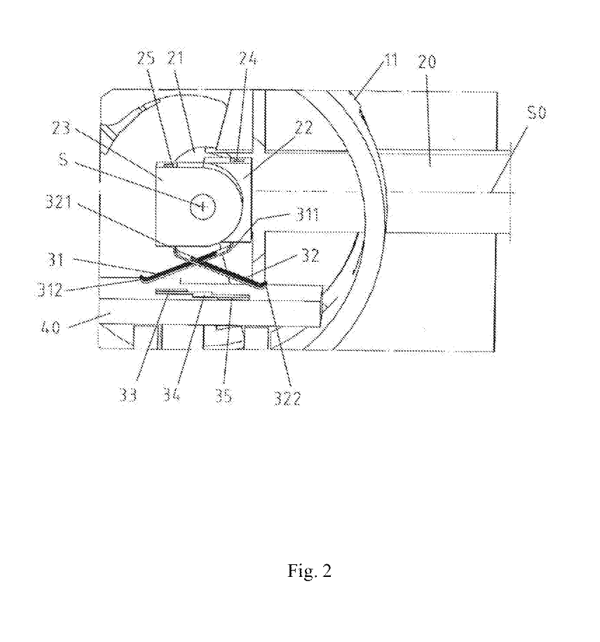

Between two closed positions S1 and S2 there is an off position S0, as shown in FIGS. 1 and 2, a mean swivel position of the switching lever 20. This is, in the off position S0, there is no connection with the electric driving device. Both sliding contacts 31, 32 are at a distance from the connection plate 40 and thus at a distance from the contact tracks 33, 34, 35, as best seen in FIG. 2.

By a pivoting movement of the switching lever 20 about its pivot axis S, which here is also the central axis of the sleeve-shaped projection 11, the sliding contacts 31, 32 are moved, since these sliding contacts 31, 32 received with their contact arms 311, 321 in a bearing bushing 21 of the switching lever 20. The bushing 21 extends around the pivot axis S.

For receiving the contact arms 311, 321 of the sliding contacts 31, 32, the bearing bushing 21 comprises receiving slots, which are introduced into lugs 22, 23 of the bearing bushing 21. These lugs 22, 23 are arranged on the bearing bushing 21, that in the off position S0 of the switching lever 20, the receiving slots for the contact arms 311, 321 extend perpendicular to the connection plate 40.

The receiving slots in the lugs 22, 23 of the bearing bushing 21 each connects to a plug-in socket 24, 25. These plug-in sockets 24, 25 are provided for corresponding electrical lead wires connected to the sliding contacts 31, 32. These lead wires, not shown, are guided through a passage 14 in the bearing plate 12 to the plug-in sockets 24, 25.

The lugs 22, 23 on the bearing bushing 21 are oriented in different directions starting from the pivot axis S and provided axially one behind the other, so that the sliding contacts 31, 32 moves in adjacent planes. Also in at least one embodiment, as shown in FIG. 2, where the sliding contacts 31, 32 are bent outside of the bearing bush 21 along different directions, specifically, the sliding contact 31 arranged in the right of the pivot axis S bends to the left, and the sliding contact 32 arranged in the left of the pivot axis S bends to the right, the movements of the sliding contacts 31, 32 do not intersect, since the sliding contacts 31,32 move in adjacent planes which are arranged in successively planes along the axial direction of the bearing bushing 21.

The movement planes of the sliding contacts 31, 32 make it possible to contact with the linearly aligned contact tracks 33, 34, 35 extending transversely to the pivot axis S. These contact tracks 33, 34, 35 are arranged parallel to one another, namely so that the contact tracks 33, 34 move in the movement space of the sliding contact 31 and the contact tracks 34, 35 are in the movement space of the sliding contact 32. This arrangement is particularly space-saving.

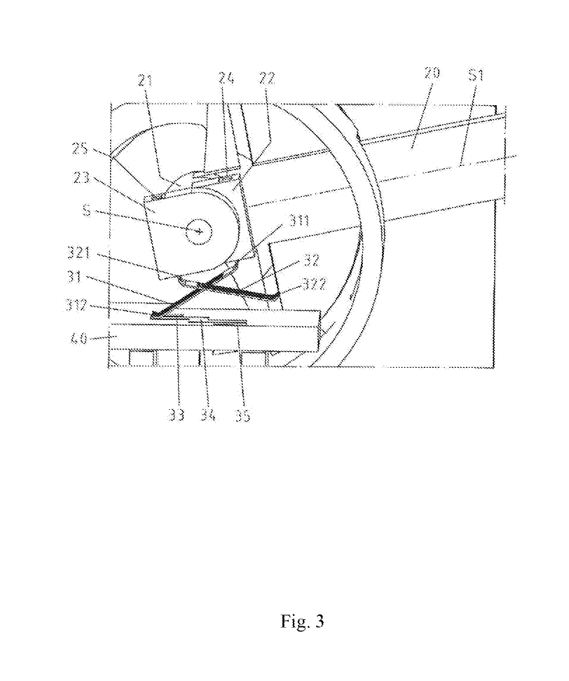

When the switching lever 20, starting from FIG. 2, is pivoted upwards into the closed position S1, shown in FIG. 3, the sliding contact 31 is lowered so that its end-side contact tongue 312 contacts the contact paths 33, 34 in electrical contact and makes an electrical rotary movement of the electric driving device causes, which triggers the curtain to be pulled up. The other sliding contact 32 is further moved away from the connection plate 40 by this pivoting movement of the switching lever 20 and has no contact with the contact tracks 34, 35.

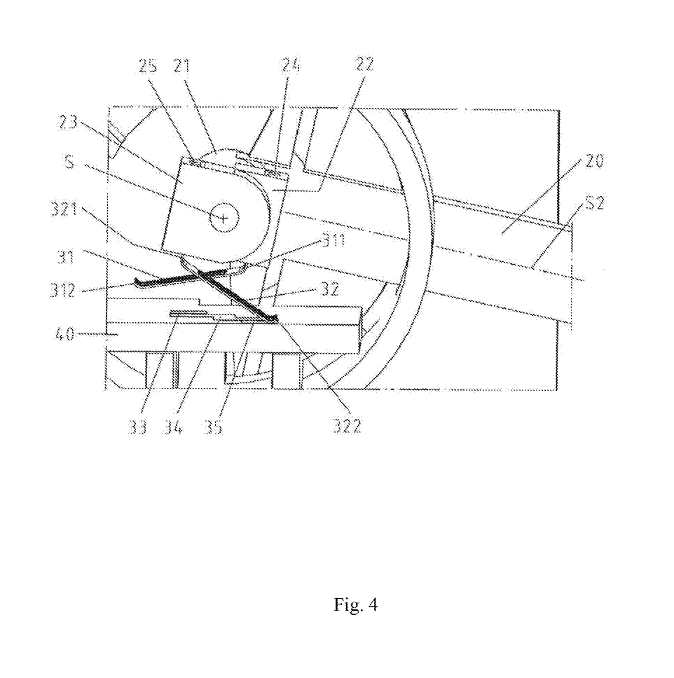

However, when the switching lever 20 is pivoted in the opposite direction, namely in the closed position S2 shown in FIG. 4, the sliding contact 32 is lowered by this pivoting movement to the terminal plate 40, the sliding contact 32 is contacted with the contact tracks 34, 35, which trigger the electric driving device in the opposite rotary direction, and triggers the curtain to be pulled down therefore. During this pivoting movement of the switching lever 20, the first sliding contact 31 is lifted away from the connection plate 40 and no longer has any contact with the contact paths 33, 34. In at least one embodiment, the contact tongues 312, 322 may be U-shaped, so that the resilient contact tongues provide sufficient contact pressure.

If the switching lever 20 is swiveled from the closed position S1 into the other closed position S2, it must always pass through the middle pivot position which corresponds to the off position S0. This advantageously results in the movement of the curtain being stopped before the curtain is moved to the opposite direction.

The arrangement of the contact system with the sliding contacts 31, 32 and the contact tracks 33, 34, 35 in the bearing bushing 21 constitutes a compact short construction of the switching device 1. The switching lever 20, which protrudes from the sleeve-shaped projection 11 of the bearing element 10, can be manually operated or be actuated via a control device.

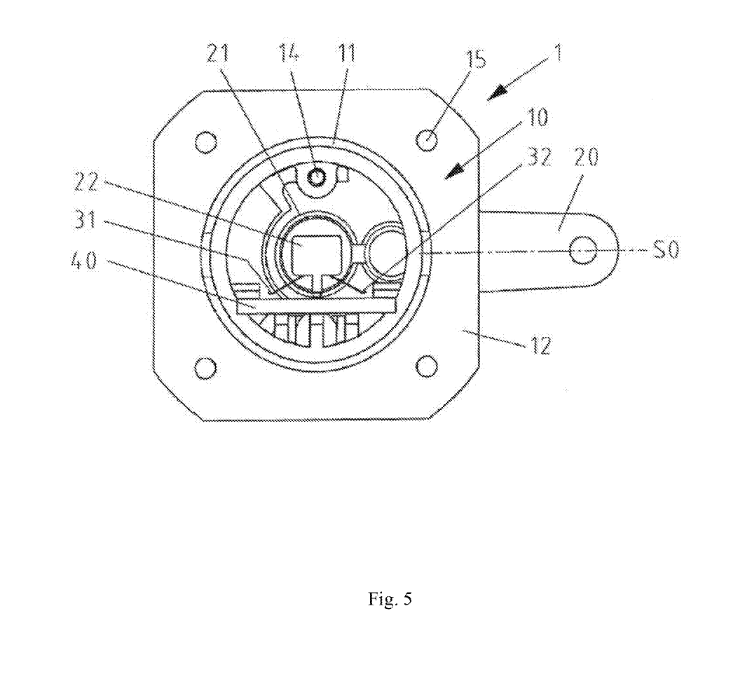

FIGS. 5 to 14 show a further embodiment of a switching device 1. The same reference numerals have been used for the same components. Also in this embodiment, the switching device 1 comprises a contact system of sliding contacts 31, 32 on the one hand and contact tracks 33, 34, 35 on the other. The contact tracks 33, 34, 35 are located on one side of the connection plate 40. This contact system is housed in a sleeve-shaped projection 11 of a bearing element 10. This cup-shaped bearing element 10 comprises the sleeve-shaped projection 11 and a bearing plate 12. In at least one embodiment, the switching lever 20 is not disposed on the front of the bearing plate 12, but on the back.

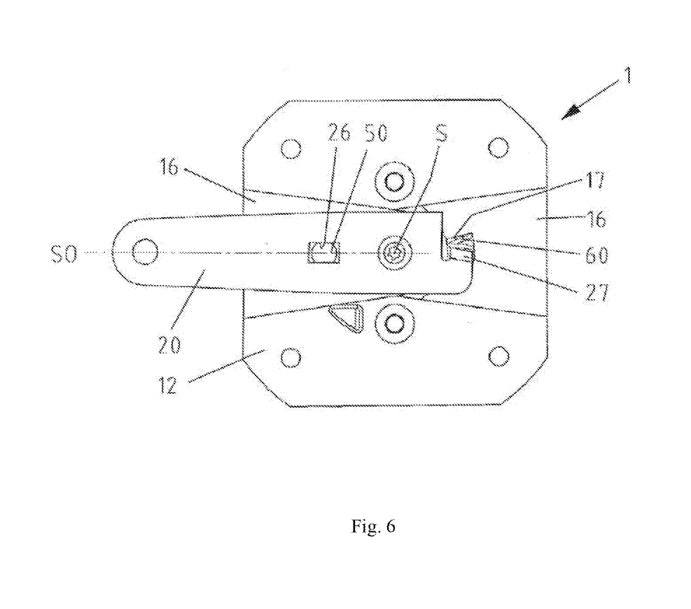

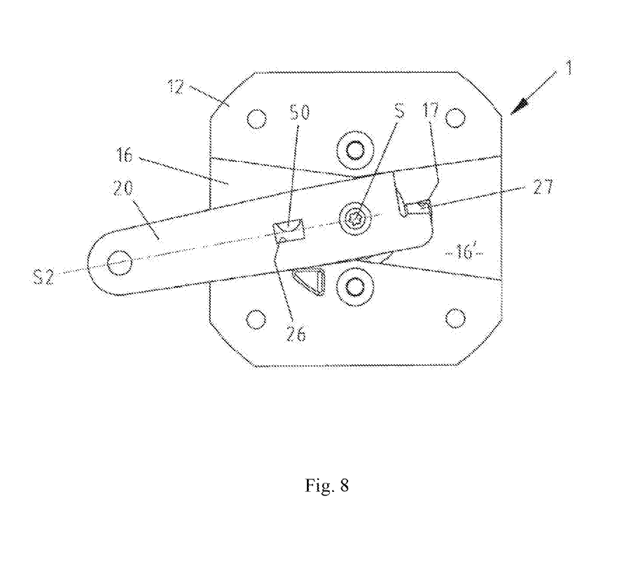

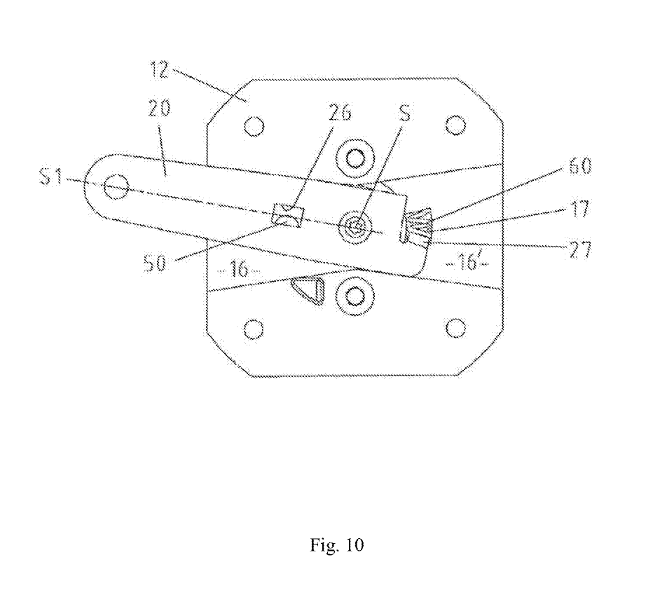

As shown in FIG. 6, the back of the bearing plate 12 comprises a corresponding recess 16, 16′ for the switching lever 20. The pivoting movement of the switching lever 20 from the off position S0, shown in FIG. 6, to the closed position S1 shown in FIG. 10 or a further closed position S2, shown in FIG. 8 takes place about the pivot axis S, wherein the switching lever 20 moves within the recess 16, 16′ of the bearing plate 12.

In the off position S0, shown in FIGS. 5 and 6, there is no connection to the electric driving device. Both sliding contacts 31, 32 are spaced from the connection plate 40 and thus at a distance from the contact track 33, 34, 35. In at least one embodiment, the sliding contacts 31, 32 are also disposed in an axially elongated projection 22 of the bearing bushing 21. This bushing 21 extends around the pivot axis S of the switching lever 20.

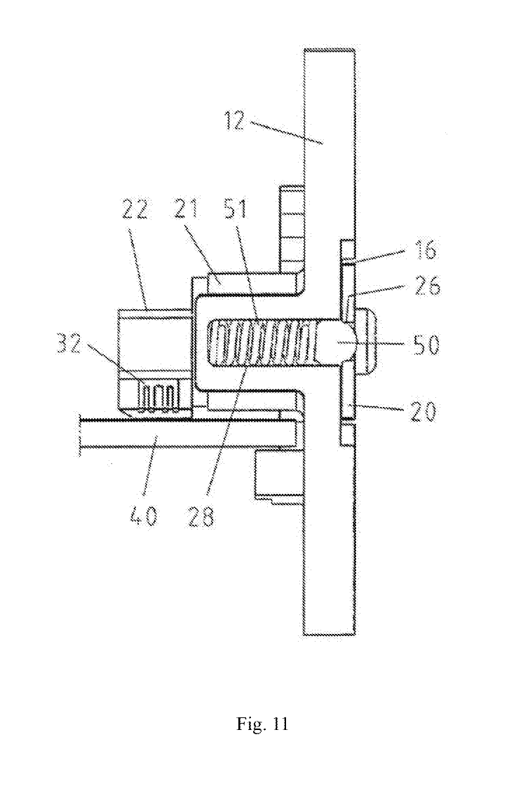

As shown in FIG. 6, preferably, a haptic feedback of the pivoting movement of the switching lever 20 is provided in at least one embodiment. The switching lever 20 comprises a groove 26 for a ball 50. As best shown in the sectional view of FIG. 11, this ball 50 is spring-loaded by a compression spring 51, the spring force from this compression spring 51 pushes the ball 50 out of a blind hole 28 of the bearing plate 12, and, if possible, in the off position S0, the ball 50 is pushed into the groove 26 of the switching lever 20.

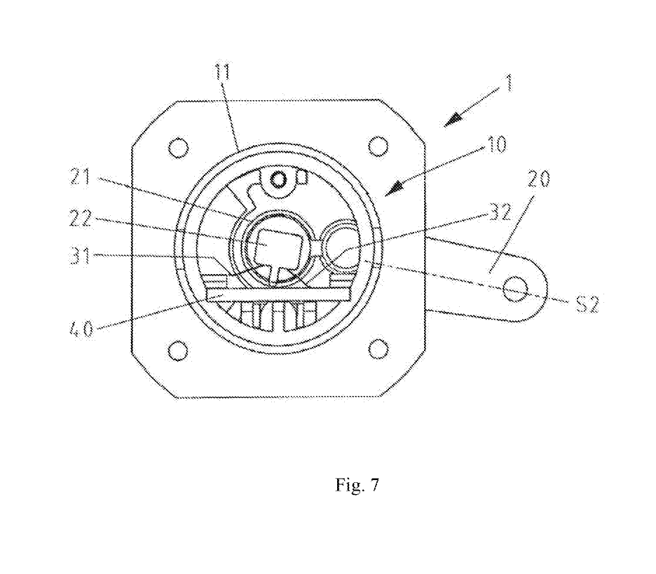

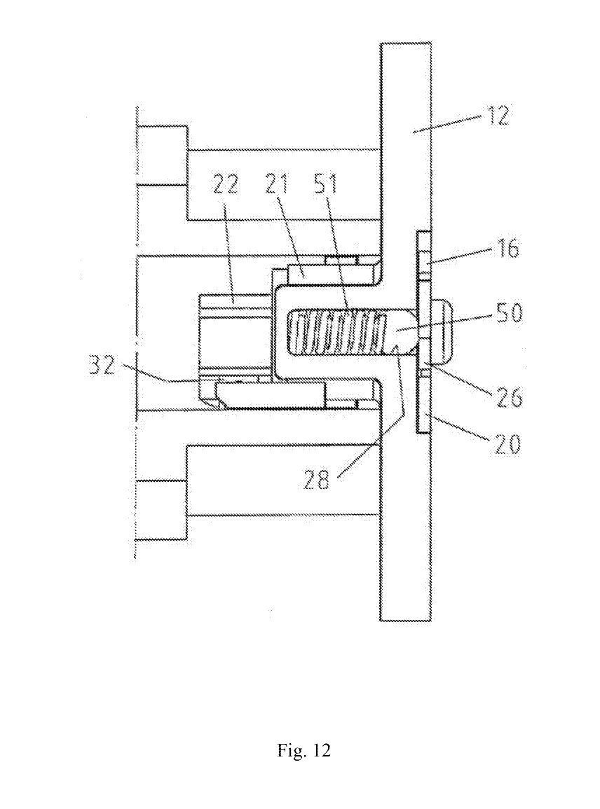

If now the switching lever 20 is pivoted into the closed position S2, as shown in FIGS. 7 and 8, the groove 26 is moved downwards with the switching lever 20 and the portion of the ball 50, as shown in FIG. 12, out of the groove 26 and the ball 50 is pushed back into the blind hole 28 against the force of the spring 51. The compression spring 51 is compressed and generates a counterforce. As a result, an increase force takes place until the portion of the ball 51 arranged in the groove 26 has been pressed completely out of the groove 26. In this case, a special haptic is generated, so that the operator knows that the controlling has been activated, namely, the switching lever 20 has been moved from its off position S0 into its closed position S2 and the sliding contact 32 contacts the contact tracks 34, 35.

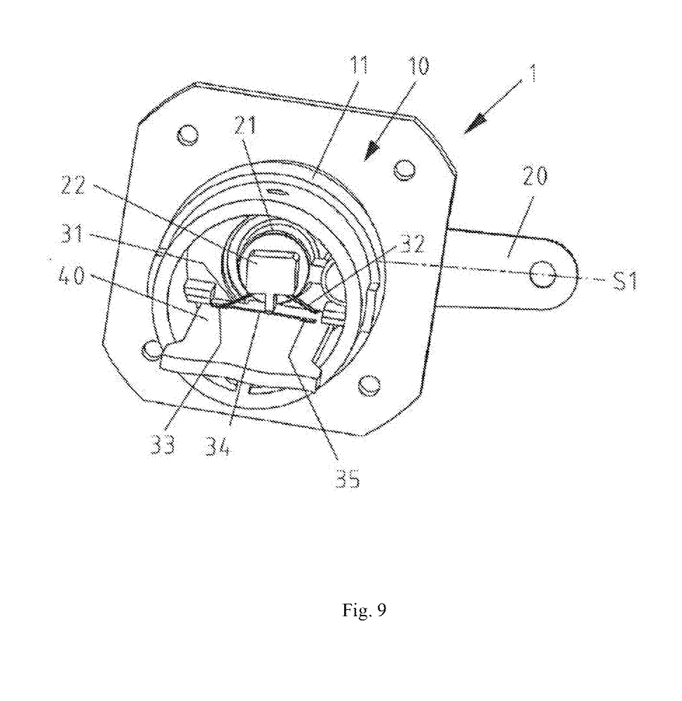

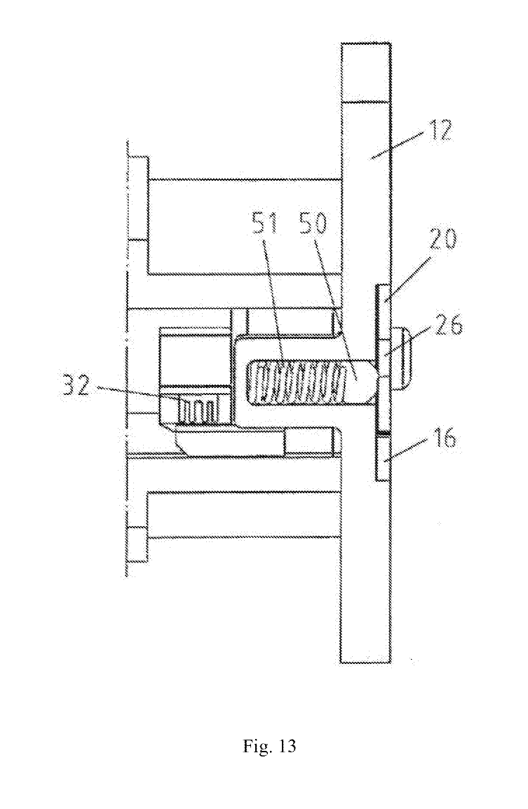

The same applies to the pivoting movement in the opposite direction, namely in the further closed position S1, as shown in FIGS. 9 and 10. In this pivotal movement, the switching lever 20 about the pivot axis S upwards, the groove 26 moves upward, as shown in FIG. 13. The ball 50 is pressed in the same way in the blind hole 28 and the compression spring 51 is compressed.

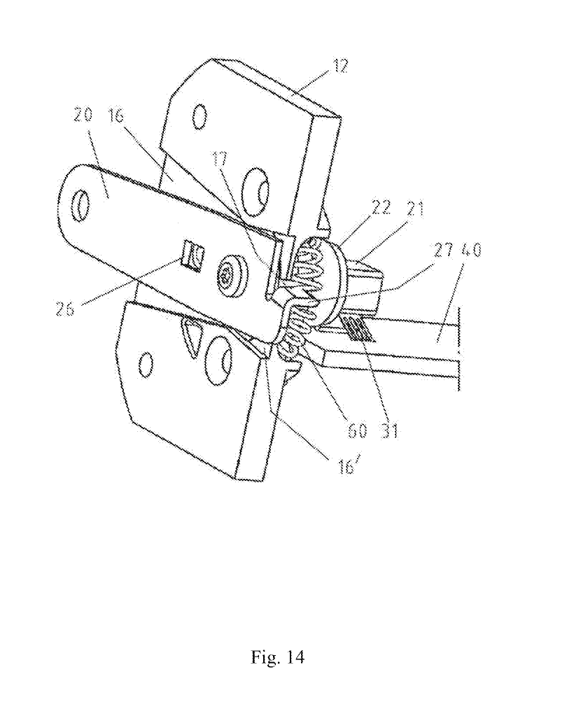

In at least one embodiment, the switching lever 20 is reset by a spring assembly 60, which is shown in the sectional view of FIG. 14. The spring assembly 60 may comprise one or more compression springs. The spring assembly 60 is arranged around the pivot axis S of the switching lever 20. The switching lever 20 has a driver 27 at the end, which is extended beyond the pivot axis S. This driver 27 passes through an opening 17 of the bearing plate 12 and is in operative connection with the spring assembly 60.

In at least one embodiment, the driver 27 is positioned between spring coils of Spring assembly 60. Thus, during the switching lever 20 pivots from the off position S0 into the closed position S1 or S2, the spring assembly 60 is also compressed. After the pivoting operation, the switching lever 20 is independently moved back to its off position S0 by the force of the spring assembly 60 stored in the above-described compression.

In the off position S0, the portion of the ball 50 is engaged with the groove 26 of the switching lever 20 and the ball 50 is pressed into the groove 26 and thus the switching lever 20 is positioned in its off position due to the pressure by the compression spring 51. In the switching device 1, the haptic feedback is realized for the operator in an advantageous manner.

In the description and claims of the present application, each of the verbs “comprise”, “include”, “contain” and “have”, and variations thereof, are used in an inclusive sense, to specify the presence of the stated item or feature but do not preclude the presence of additional items or features.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of example only, and various other modifications will be apparent to persons skilled in the field without departing from the scope of the invention as defined by the appended claims.

For example, the lead wires may contain any number of power leads and/or signal leads according to application requirements and the signal leads may include leads providing communication signals and/or leads providing information about a metric or state of the switching device.

1. A switching device, comprising:
a bearing element;
a switching lever which is movable between a plurality of pivot positions;
a contact system comprising the at least one sliding contact and corresponding contact tracks, the contact tracks are located on one side of a connection plate;
wherein the at least one sliding contact moves following the movement of the switching lever; wherein the contact tracks on the connection plate are electrically connected to an electric driving device.

2. The switching device according to claim 1, wherein the bearing element defines a sleeve-shaped projection and the contact system comprising the at least one sliding contact and the contact tracks is accommodated in the projection.

3. The switching device according to claim 1, wherein the contact tracks is arranged as a linear course and are arranged parallel to each other.

4. The switching device according to claim 1, wherein the pivot positions comprises an off position and two different closed positions, the switching lever is pivoted into two different closed positions by manually or automatic control from the off position, the off position is between the two different closed positions.

5. The switching device according to claim 2, wherein a bearing bushing is positioned in the sleeve-shaped projection, at least one lug is arranged on the bearing bushing for receiving contact arms of the sliding contacts respectively.

6. The switching device according to claim 5, wherein the bearing bushing defines receiving slots for receiving contact arms of the sliding contacts respectively.

7. The switching device according to claim 6, wherein the receiving slots in the lug of the bearing bushing each connects to a plug-in socket provided for corresponding electrical lead wires connected to the sliding contacts.

8. The switching device according to claim 1, wherein in the off position, there is no connection with the electric driving device, the at least one sliding contact is at a distance from the connection plate and at a distance from the contact tracks.

9. The switching device according to claim 4, wherein when the switching lever is to the first closed position, the sliding contact is connected to the contact paths in electrical contact which triggers an electrical rotary movement of the electric driving device in a first direction; when the switching lever is pivoted to the second closed position, the sliding contact is connected to the contact paths in electrical contact which triggers an electrical rotary movement of the electric driving device in a second direction opposite to the first direction.

10. The switching device according to claim 9, wherein the switching device is disposed in an electric powered curtain which comprises a curtain, the curtain is pulled up when the electric driving device rotates in the first direction, and the curtain is pulled down when the electric driving device is rotated in the second direction.

11. The switching device according to claim 1, wherein the bearing element comprises a sleeve-shaped projection and a bearing plate, the contact system is accommodated in the projection which is located on the front of the bearing plate.

12. The switching device according to claim 11, wherein the sleeve-shaped projection defines a slot-shaped recess on one side for the switching lever, the slot-shaped recess is dimensioned so that the switching lever in the closed position abuts one side of the slot-shaped recess.

13. The switching device according to claim 11, wherein the back of the bearing plate defines a corresponding recess for the switching lever.

14. The switching device according to claim 13, wherein the switching lever comprises a groove for a ball, the ball is spring-loaded by a spring.

15. The switching device according to claim 14, wherein the spring is compressed and located in a blind hole defined on the bearing plate, the ball is pushed into the groove of the switching lever in the off position by the spring, the ball is pushed back into the blind hole in the closed position.

16. The switching device according to claim 13, further comprising a spring assembly, wherein the spring assembly is arranged around the pivot axis of the switching lever, the switching lever comprises a driver extended at the end, beyond the pivot axis, the driver is connected to the spring assembly in operative connection.

17. The switching device according to claim 7, wherein a passage is defined on the bearing plate in the sleeve-shaped projection for routing the lead wires.

18. The switching device according to claim 7, wherein the bearing plate surrounds the sleeve-shaped projection with a flange edge and fastening openings for mounting the bearing element.
